(19) United States
(12) Patent Application Publication
(10) Pub. No.: US 2023/0162097 A1
(43) Pub. Date: May 25, 2023

(54) SYSTEM AND METHOD FOR MANAGING PARKING SPACES

(71) Applicant: Parksie LLC, Fort Collins, CO (US)

(72) Inventor: Greg Marmulak, Fort Collins, CO (US)

(21) Appl. No.: 17/983,092

(22) Filed: Nov. 8, 2022

Related U.S. Application Data
(60) Provisional application No. 63/282,483, filed on Nov. 23, 2021.

(51) Int. Cl. G06Q 10/02

(52) U.S. Cl. CPC G06Q 10/02

(57) ABSTRACT

A parking management system for managing reservations of nontraditional parking spots (NPS). The system includes a consumer device associated with a potential parker who desires to reserve an NPS and a parking control system for performing the operations of the parking management system. The system can receive a request for an NPS at a desired date, time and location from the potential parker. The system can determine availability of any NPSs that fit the request and generate a list of NPSs. A method of managing a nontraditional parking spot (NPS). The method includes the step of receiving a request, at a parking control system, for an NPS for a desired date, time and location from a potential parker via a consumer device. The method also includes the step of determining availability of NPSs that fit request parameters of the request and generating a list of NPSs that fit the request parameters of the request and sending the list of NPSs to the consumer device of the potential parker.

### CROSS-REFERENCE TO RELATED APPLICATIONS

The present application is a conversion of U.S. Provisional Application having U.S. Ser. No. 63/282,483, filed Nov. 23, 2021, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The disclosure relates to a parking management system for providing a parking spot owner the capability of monitoring the rental of their parking spots and for providing a prospective parker the ability to park in nontraditional locations.

### 2. Brief Description of Related Art

Typically, when not on a person's own personal property, parking occurs in traditional locations, such as parking lots, parking garages, edges of the street, etc. In certain situations, traditional parking locations can be overburdened. For example, traditional parking locations in a downtown area during business hours or traditional parking locations surrounding a special event, such as a sporting event, are routinely overburdened. In these and other situations, traditional parking locations cannot keep up with demand.

Accordingly, there is a need for a technology-based solution that allows a parking spot owner to be able to provide access to their parking spot for a person in need of a parking spot in a particular area.

### SUMMARY OF THE DISCLOSURE

The present disclosure is directed to a parking management system for managing reservations of nontraditional parking spots (NPS). The parking management system includes a consumer device associated with a potential parker who desires to reserve an NPS and a parking control system for performing the operations of the parking management system. The parking control system can receive a request for an NPS at a desired date, time and location from the potential parker. The parking control system can determine availability of any NPSs that fit the request and generate a list of NPSs.

The present disclosure is also directed to a method of managing a nontraditional parking spots (NPS). The method includes the step of receiving a request, at a parking control system, for an NPS for a desired date, time and location from a potential parker via a consumer device. The method also includes the step of determining availability of NPSs that fit request parameters of the request and generating a list of NPSs that fit the request parameters of the request and sending the list of NPSs to the consumer device of the potential parker.

### BRIEF DESCRIPTION OF THE DRAWINGS

FIG. 1 is a diagram showing a parking management system constructed in accordance with the disclosure.

FIG. 2 is a flow chart showing a general process of the parking management system constructed in accordance with the disclosure.

FIG. 3 is a diagram showing a parking control system incorporated by the parking management system in accordance with the disclosure.

FIG. 4 is a screenshot from a device used with the parking management system constructed in accordance with the disclosure.

FIGS. 5A-5G is a series of screenshots from a device associated with a potential parker used with the parking management system constructed in accordance with the disclosure.

FIG. 6A-6I is are a series of screenshots from a device associated with a parking spot owner used with the parking management system constructed in accordance with the disclosure.

FIG. 7 is a screenshot from a device associated with the parking spot owner used with the property showing management system constructed in accordance with the disclosure.

### DETAILED DESCRIPTION OF THE DISCLOSURE

The present disclosure relates to a parking management system (PMS) 10 for providing a parking spot owner a mechanism to rent their parking spots to people in need of parking. The PMS 10 also provides people who are in need of a parking spot in a particular geographic area a mechanism to find and reserve parking spots that can be considered nontraditional. It should be understood and appreciated that the PMS 10 could also be used to find and reserve any type of parking spots if desired. Examples of nontraditional parking spots (NPS) include, but are not limited to, driveways of residences, yards of residences, property around a building not typically used for parking, parking spots of businesses not typically available to the public, barns, fields, empty lots, etc. Typically, when a person wants to park they drive to the general area where they want to park and they drive around and search for a parking space in traditional parking places. There are situations where traditional parking spaces are unavailable and nontraditional parking spaces are used. The PMS 10 described herein can be used by any person desirous of parking a vehicle, airplane, helicopter, trailer, piece of equipment, or any apparatus that can be towed by a vehicle, in a nontraditional parking space. Vehicles can include, but are not limited to, cars, trucks, vans, RVs, buses, tractors, semis, etc. A piece of equipment can include any device capable of being pulled or towed by a vehicle that may not have wheels or tracks, such as a piece of farm equipment that is pulled by a tractor or farm vehicle.

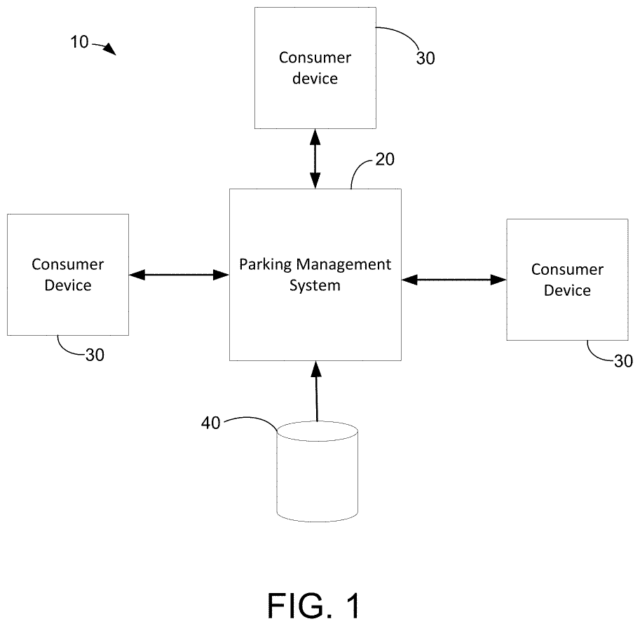

Referring now to the drawings, and more particularly, FIG. 1 shown therein is the PMS 10. The PMS 10 includes a parking control system 20 for facilitating the operations of the PMS 10. The parking control system 20 is configured to send and receive data to and from a consumer device 30. The parking control system 20 is also configured to carry out all operations of the PMS 10 described herein. The consumer device 30 can be a tablet, smart phone or computer used by a consumer (real estate transaction participant) that is running an application (app) or accessing a webpage associated with the PMS 10. The parking control system 20 of the PMS 10 is capable of receiving and sending data to numerous consumer devices 30. The parking control system 20 can be configured to receive data from a nontraditional parking database 40. The nontraditional parking database 40 can include information and details regarding nontraditional parking spots provided by parking spot owners. Information and details about the NPSs can include, but it not limited to, the address of the NPS, the size vehicle the NPS can accommodate, the availability of the NPS, specific geolocation of the NPS, access instructions for the NPS, pricing of the NPS (hourly, daily, weekly, overcharge, etc.), etc.

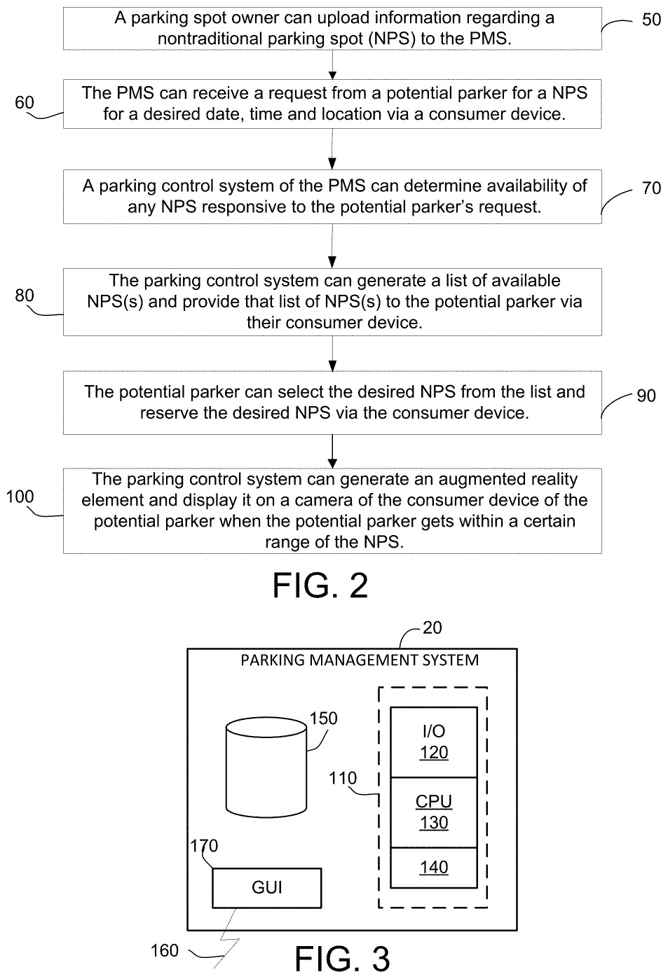

Referring now to FIG. 2, shown therein is a flow chart showing a general process the PMS 10 manages. At step 50, a parking spot owner can upload information and details regarding their NPS(s) to the PMS 10 via the consumer device 30. The parking control system 20 can receive a parking request from a potential parker any NPS for a desired date, time limit and/or location (or within a certain proximity to a location) at step 60. The parking control system 20 can then conduct operation 70 and determine availability of any NPS(s) in the nontraditional parking database 40 that are responsive to the parking request made by the potential parker via the consumer device 30. The parking control system 20 can then generate a list of available NPSs and provide that list of NPSs (and any information and details) to the potential parker via the consumer device 30 at step 80. The potential parker can then perform operation 90 and reserve the desired NPS. After the potential parker reserves the NPS, the potential parker can then travel to the NPS to park. The potential parker can be guided to the reserved NPS by their memory and knowledge of the area, via a map feature of the PMS 10, or via a map feature of the consumer device 30 the PMS 10 is in an operational relationship with, such as google maps or apple maps.

At step 100, the parking control system 20 can conduct an operation to generate an augmented reality element displayable on the potential parker's consumer device 30. The location of the augmented reality element is based upon the location data entered for the associated NPS. More specifically, the augmented reality element can be associated with the geolocation of the NPS. As the potential parker navigates to within a certain distance of the NPS, a camera view can be displayed on the consumer device 30 wherein the augmented reality element is visible on the camera screen when the camera is pointed at the NPS to demonstrate exactly where the NPS is located. The augmented reality element can be any shape, color and size to demonstrate to the potential parker where the NPS is located. For example, the augmented reality element could be a downward pointing arrow or a pin of any color and include a background shape of any color and size. The augmented reality element will stay fixed to the NPS even as the potential parker moves the consumer device 30. As long as the NPS is visible on the camera of the consumer device 30, the augmented reality element will be visible on the consumer device 30. In certain embodiments, the augmented reality element can be displayed on the camera of the consumer device even when the NPS is not in a direct line of sight. It can be shown in the camera to indicate a general direction of the NPS in the scenario where the NPS is not in a direct line of sight yet.

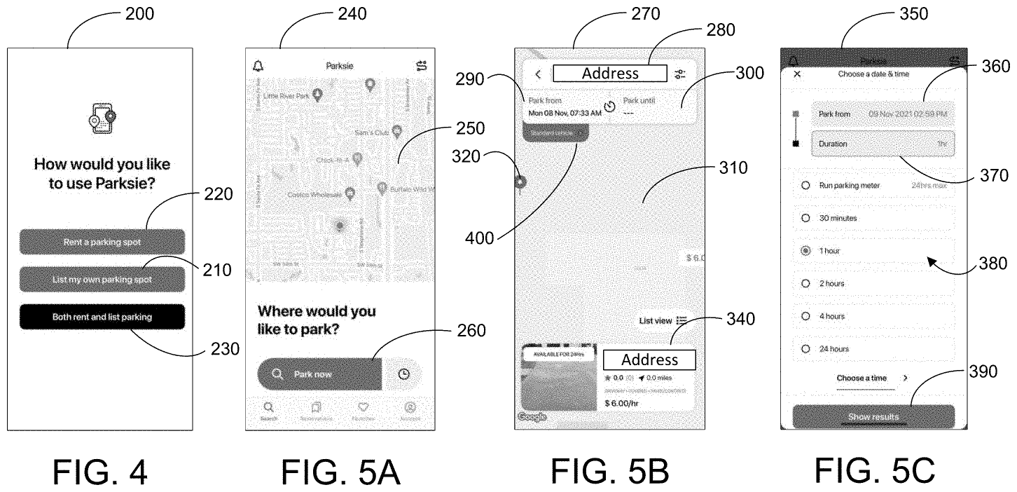

Referring now to FIG. 3 shown therein is a diagram of the parking control system 20. The parking control system 20 is capable of executing a computer program product embodied in a tangible processor-readable storage medium to execute a computer process. Data and program files may be input into the parking control system 20, which reads the files and executes the programs therein using one or more processors. Some of the elements of the parking control system 20 are shown in FIG. 3, wherein a processor 110 is shown having an input/output (I/O) section 120, a Central Processing Unit (CPU) 130, and a memory section 140. There may be one or more processors 110, such that the processor 110 of the parking control system 20 comprises a single central-processing unit 130, or a plurality of processing units. The processors may be single-core or multi-core processors. The parking control system 20 may be a conventional computer, a distributed computer, or any other type of computer. The described technology is optionally implemented in software loaded in memory 140, a disc storage unit 150, and/or communicated via a wired or wireless network link 160 on a carrier signal (e.g., Ethernet, 3G wireless, 1G wireless, LTE (Long Term Evolution), 5G) thereby transforming the parking control system 20 in FIG. 3 to a special purpose machine for implementing the described operations.

The I/O section 120 may be connected to one or more user-interface devices (e.g., a keyboard, a touch-screen display unit, etc.) or a disc storage unit 150. Computer program products containing mechanisms to effectuate the systems and methods in accordance with the described technology may reside in the memory section 140 or on the storage unit 150 of the parking control system 20.

The parking control system 20 can also include a communication interface 170 capable of connecting the parking control system 20 to an enterprise network via the network link 160, through which the parking control system 20 can receive instructions and data embodied in a carrier wave. When used in a local area networking (LAN) environment, the parking control system 20 is connected (by wired connection or wirelessly) to a local network through the communication interface 170, which is one type of communications device. When used in a wide-area-networking (WAN) environment, the parking control system 20 typically includes a modem, a network adapter, or any other type of communications device for establishing communications over the wide-area network. In a networked environment, program modules depicted relative to the parking control system 20 or portions thereof may be stored in a remote memory storage device. It is appreciated that the network connections shown are examples of communications devices for, and other means of establishing a communications link between the computers may be used.

In an example implementation, a browser application, a compatibility engine applying one or more compatibility criteria, and other modules or programs may be embodied by instructions stored in memory 140 and/or the storage unit 150 and executed by the processor 110. Further, local computing systems, remote data sources and/or services, and other associated logic represent firmware, hardware, and/or software, which may be configured to manage rental requests for the NPSs. The parking control system 20 of the PMS 10 may be implemented using a general purpose computer and specialized software (such as a server executing service software), a special purpose computing system and specialized software (such as a mobile device or network appliance executing service software), or other computing configurations. In addition, user requests, profiles and parameter data, agent profiles and parameter data, location data, parameter matching data, and other data may be stored in the memory 140 and/or the storage unit 150 and executed by the processor 110.

The embodiments of the invention described herein are implemented as logical steps in one or more computer systems. The logical operations of the present invention are implemented (1) as a sequence of processor-implemented steps executed in one or more computer systems and (2) as interconnected machine or circuit modules within one or more computer systems. The implementation is a matter of choice, dependent on the performance requirements of the computer system implementing the invention. Accordingly, the logical operations making up the implementations of the invention described herein are referred to variously as operations, steps, objects, or modules. Furthermore, it should be understood that logical operations may be performed in any order, adding and omitting as desired, unless explicitly claimed otherwise, or a specific order is inherently necessitated by the claim language.

Data storage and/or memory may be embodied by various types of storage, such as hard disk media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” (e.g., memory 140) means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” or “storage medium” expressly does not include a transitory medium, such as a carrier signal, but the computer instructions can be transferred to the memory wirelessly.

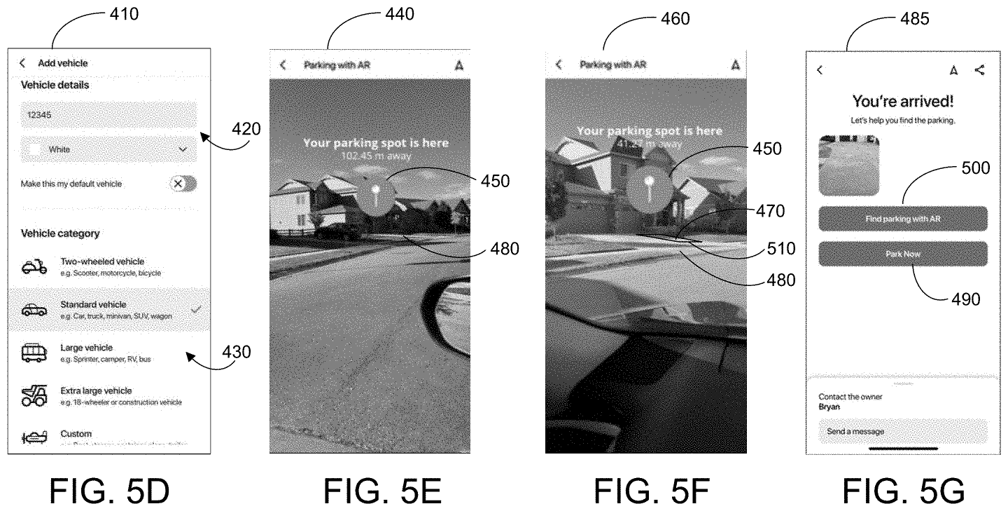

Referring now to FIGS. 4-7, shown therein are screens shots taken from a consumer device 30 that has an application associated with the PMS 10. FIG. 4 is a screenshot 200 showing a home screen having a parking spot button 210 for a parking spot owner to use to navigate to various parts of the application where the parking spot owner can input information regarding a parking spot to be listed on the application. The screenshot 200 can also include a parker button 220 for a potential parker to execute to navigate to various parts of the application the potential parker can use to find a parking spot in a desired area. The screenshot 200 can also include a combo button 230 that can be executed by a person who uses the application for finding potential parkers for their parking spots and uses the application to find potential parking spots for parking their own vehicle.

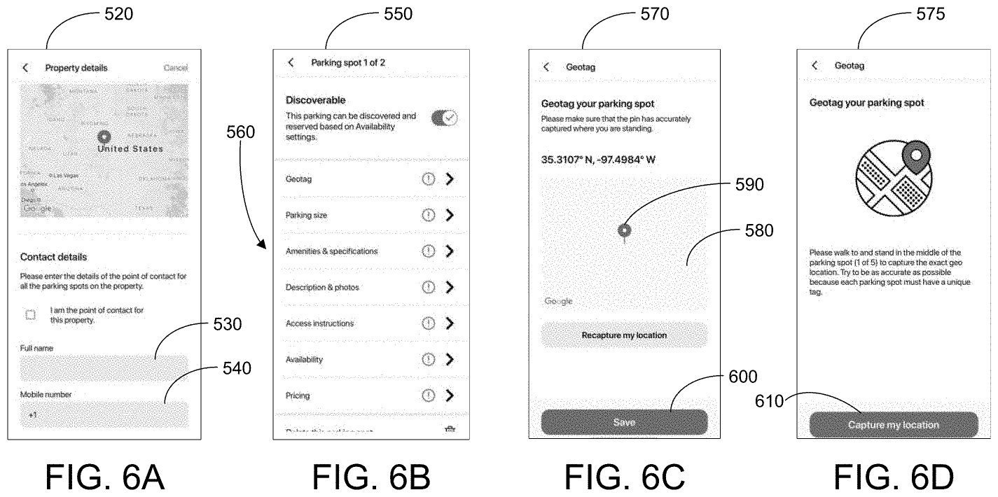

FIGS. 5A-5G show various screenshots from the application associated with the PMS 10 that show various functionalities of the application for potential parkers. FIG. 5A is a screenshot 240 of an introductory screen for a potential parker. The screenshot 240 shows a map 250 and a button 260 that permits a potential parker to begin finding a desired parking spot. Once the button 260 is executed by the potential parker they are taken to screen 270 shown in FIG. 5B. Here the potential parker can enter an address in an area they would like to find parking in an address bar 280. Screen 270 also has a park from box 290 and park until box 300 where the potential parker can enter the date and time they intend to need the parking spot. The screen 270 can also include a map 310 showing the area where the parking spot is desired and a certain amount of surrounding area. The map 310 will have a pin 320 dropped at the address entered and show potential parking spots marked by other parking pins 330. Screen 270 can also include a summary box 340 that details specifics for each parking spot associated with each parking pin 330 shown in the map 310. Examples of specifics shown in the summary box 340 include, but are not limited to, address of parking spot, cost of parking spot, a picture of the parking spot, etc.

The application can also be set up that when the park from box 290 is executed, the potential parker is taken to screen 350 shown in FIG. 5C. On screen 350, the potential parker can enter the time the potential parker intends to begin needing a parking spot in another park from box 360 and enter an amount of time the potential parker will need the parking spot in a duration box 370. A dropdown menu 380 providing different lengths of time for the potential parker to choose from can pop up when the potential parker begins interacting with the duration box. Once the duration is selected by the potential parker, a show results box 390 can be executed and the potential parker can be taken back to screen 270.

Screen 270 in FIG. 58 also includes a vehicle tab 400 that when executed can bring up screen 410 shown in FIG. 5D where the potential parker can enter information about the potential parker's vehicle in info boxes 420. The number of info boxes 420 can vary depending on the information desired to be obtained about the potential parker's vehicle. Examples of information can include, but is not limited to, license plate information, vehicle color, vehicle make, vehicle model, etc. Screen 410 can also include a vehicle type section 430 where the potential parker can select which type of vehicle the potential parker has, such as a two-wheeled vehicle, standard vehicle, large vehicle, extra-large vehicle, custom vehicle, etc.

Once all the vehicle information and desired parking space information is entered, the application provides a gps map screen (not shown) where the potential parker's position is shown on the map and step-by-step directions to the parking spot are also provided similar to what is provided on other mapping applications. In one embodiment, once the potential parker gets within a certain distance of the parking spot that has been reserved, a screen 440 can pop up to showing a camera view showing an augmented reality icon 450 where the actual parking spot is located. Screen 460 shows another view from the camera where the potential parker is closer to the parking spot. FIGS. 5E and 5F show camera views where the augmented reality icon 450 is positioned in the camera view over the parking spot to show exactly where the parking spot is. In the instant example, the augmented reality icon is positioned on a driveway 460, but it is not associated with the entire driveway 460. It is associated with a specific part 470 of the driveway 480. It should be understood and appreciated that the driveway could be broken down into multiple parking spots and the augmented reality icon 450 would be associated with the specific part 470 that has been designated for the parking spot.

In another embodiment, when the potential parker gets within a certain distance of the parking spot (very close), screen 485 is displayed by the application on the potential parker's consumer device 30, which is depicted by FIG. 5G. If the parking spot is obvious to the potential parker, the potential parker can execute a park now button 490 and park. If it is not obvious where the actual parking spot is, the potential parker can execute an AR button 500 and a screen like that shown in FIG. 5E or 5F will be provided on by the application on the potential parker's consumer device 30. The augmented reality icon 450 will show the potential parker exactly where the parking spot is. The augmented reality icon 450 can be any design desirable. In the instant application, the augmented reality icon 450 is a pin with a circle around, but it can be a generic vehicle that matches the type of vehicle being parked. The augmented reality icon 450 can also include a border 510 that shows the boundary of the specific parking spot the potential parker has reserved.

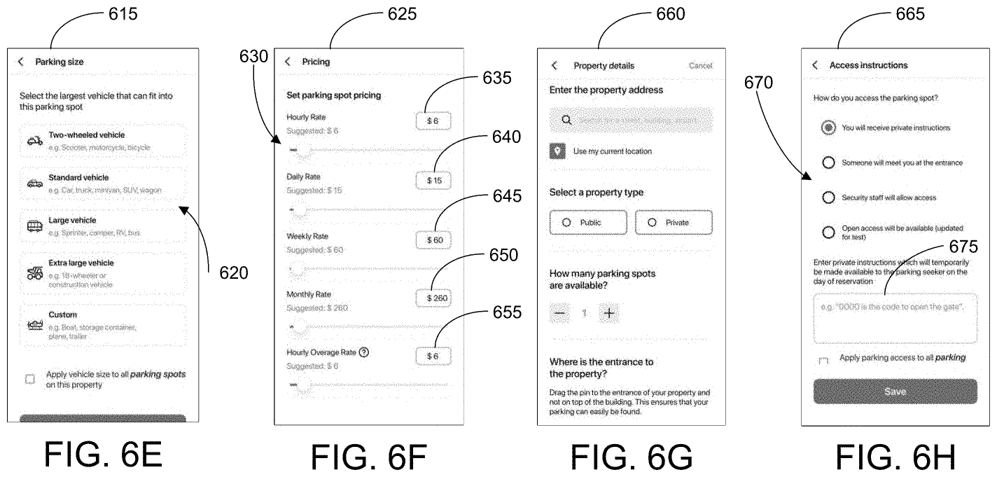

FIGS. 6A-6I show various screenshots from the application associated with the PMS 10 that show various functionalities of the application for parking spot owners. FIG. 6A is a screenshot 520 where property details, such as contact details for the parking spot owner, for the parking spot can be entered. Screenshot 520 has a name section 530 where the parking spot owner's name can be entered and a phone section 540 where the parking spot owner's phone number can be entered. The application can be set up where any other information for the parking spot owner can be entered. FIG. 6B shows a parking info home screen 550 that provides various info tabs 560 that when executed take the parking spot owner to other screens where various details about the parking spot can be entered. Details about the parking spot include, but are not limited to, geotag data, parking spot size, description and/or photos of the spot, access instructions, availability, pricing, etc.

FIGS. 6C and 6D show a first geotag screenshot 570 and a second geotag screenshot 575 that the parking spot owner can use to mark the exact geo location of the parking spot. On the first geotag screenshot 570, a map 580 with a pin 590 on the map 580 showing the exact location of the parking spot owner (or rather the consumer device 30 of the parking spot owner). The screenshot 570 also shows the latitude and longitude of the area on the map 580 associated with the parking spot. The screenshot 570 can also include a save button 600 that can be executed when the geo location of the parking spot is set, which sends the parking spot owner back to the home screen 550. On screenshot 575, the parking spot owner can move to the center of the parking spot and hit a capture button 610 that captures the geo location of parking spot.

Screenshot 615 shown in FIG. 6E provides the parking spot owner with a series of tabs 620 where the parking spot owner can select which type of vehicle the parking spot can accommodate, such as a two-wheeled vehicle, standard vehicle, large vehicle, extra-large vehicle, custom vehicle, etc. Screenshot 625 shown in FIG. 6F shows a list 630 of pricing options for the parking spot. For example, the list can include an hourly rate section 635, a daily rate section 640, a weekly rate section 645, a monthly rate section 650, an hourly overage rate section 655, etc. Screenshot 660 shown in FIG. 6G provides the parking spot owner a screen to enter property details for the parking spot, such as property address, property type (public or private), number of spots, etc. Screenshot 665 shown in FIG. 6H provides the parking spot owner the ability to provide access instructions for the parking spot. The screenshot 665 can have general access tabs 670 that provide standard instructions. The screenshot 665 also has a custom access instruction section 675 where the parking spot owner can enter any additional details about the parking spot. Screenshot 680 shown in FIG. 6I provides a summary of the information entered into the application for the parking spot by the parking spot owner.

The application can also provide the parking spot owner with the ability to monitor the revenue generated by the parking spot.

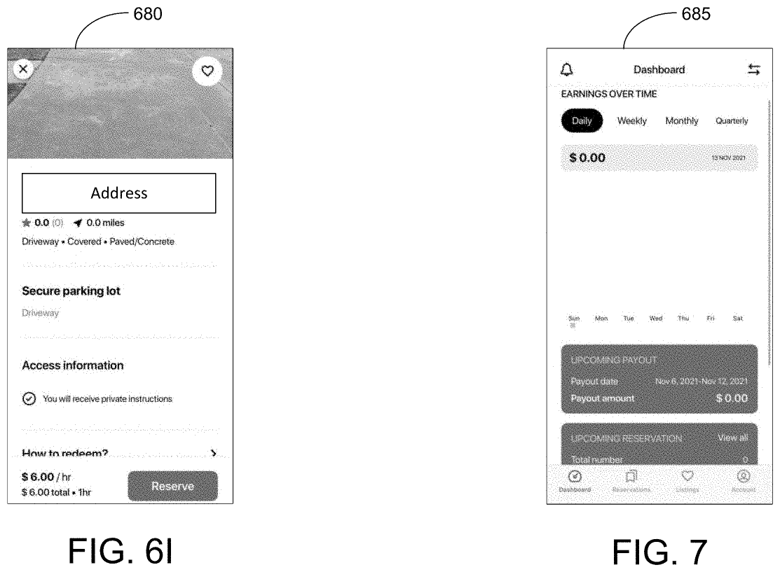

Screenshot 685 shown in FIG. 7 is a dashboard that shows various information about the parking spot relative to earnings generated by the parking spot. Also shown are upcoming payouts and reservations for the spot.

From the above description, it is clear that the present invention is well-adapted to carry out the objectives and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A parking management system for managing reservations of nontraditional parking spots (NPS), the parking management system comprising:
a consumer device associated with a potential parker who desires to reserve an NPS; and
a parking control system for performing the operations of the parking management system, the parking control system receives a request for an NPS at a desired date, time and location from the potential parker, determines availability of any NPSs that fit the request, and generates a list of NPSs.

2. The system of claim 1 further comprises a second consumer device associated with an owner of a NPS.

3. The system of claim 2 wherein the parking control system receives parking spot information from the owner of a NPS related to the NPS via the second consumer device.

4. The system of claim 1 wherein the parking control system provides a map with directions to an NPS selected from the list of NPSs provided by the parking control system.

5. The system of claim 4 wherein the parking control system provides a camera view of the NPS when the potential parker gets within a certain distance of the NPS.

6. The system of claim 5 wherein the camera view includes an augmented reality icon that shows specifically where the NPS is located.

7. The system of claim 6 wherein the augmented reality icon can be a border that shows an exact location of the NPS on the ground.

8. The system of claim 3 wherein the parking spot information includes a specific geolocation of the NPS.

9. The system of claim 3 wherein the parking spot information includes a size of the NPS.

10. A method of managing a nontraditional parking spots (NPS), the method comprising:
receiving a request, at a parking control system, for an NPS for a desired date, time and location from a potential parker via a consumer device,
determining availability of NPSs that fit request parameters of the request; and
generating a list of NPSs that fit the request parameters of the request and sending the list of NPSs to the consumer device of the potential parker.

11. The method of claim 10 further comprising receiving parking spot information from an owner of a NPS related to a particular NPS.

12. The method of claim 11 wherein the parking control system receives the parking spot information from a second consumer device associated with the owner of the NPS.

13. The method of claim 10 wherein the parking control system provides a map with directions to an NPS selected from the list of NPSs provided by the parking control system.

14. The method of claim 13 wherein the parking control system provides a camera view of the NPS when the potential parker gets within a certain distance of the NPS.

15. The method of claim 14 wherein the camera view includes an augmented reality icon that shows specifically where the NPS is located.

16. The method of claim 15 wherein the augmented reality icon can be a border that shows an exact location of the NPS on the ground.

17. The method of claim 12 wherein the parking spot information includes a specific geolocation of the NPS.

18. The method of claim 12 wherein the parking spot information includes a size of the NPS.
